(19) United States
(12) Patent Application Publication
(10) Pub. No.: US 2014/0279573 A1
(43) Pub. Date: Sep. 18, 2014

(54) SYSTEM AND METHOD FOR AUTOMATIC AND INTELLIGENT FORM GENERATION

(71) Applicant: Walter E. Coats Revocable Trust, Westminster, CO (US)

(72) Inventors: Walt Coats, Golden, CO (US); Gary Gregg, Denver, CO (US); Brian Agnes, Denver, CO (US); Gary Ferguson, Erie, CO (US)

(73) Assignee: Walter E. Coats Revocable Trust, Westminster, CO (US)

(21) Appl. No.: 14/213,405

(22) Filed: Mar. 14, 2014

Related U.S. Application Data
(60) Provisional application No. 61/794,346, filed on Mar. 15, 2013.
(60) Provisional application No. 61/861,707, filed on Aug. 2, 2013.

(51) Int. Cl. G06Q 30/02; G06Q 50/16

(52) U.S. Cl. CPC G06Q 30/0278; G06Q 50/16
USPC 705/306

(57) ABSTRACT

Methods, devices, and systems are provided for the automatic development of forms and processes used to provide real property valuations. A valuation work order is created that includes a valuation type for a specific subject property. The valuation work order is assigned to a valuation agent and valuation data is input into a digital valuation form. Valuation data is collected from multiple sources. Upon completing the digital valuation form, the digital valuation for is checked for errors and a standard form corresponding to a standard real property valuation form is automatically generated.

### CROSS REFERENCE TO RELATED APPLICATIONS

The present application claims the benefit of and priority, under 35 U.S.C. §119(e), to U.S. Provisional Application Ser. No. 61/794,346, filed on Mar. 15, 2013, entitled “SYSTEM AND METHOD FOR REAL ESTATE VALUATION,” and U.S. Provisional Patent Application Ser. No. 61/861,707, filed Aug. 2, 2013, entitled “REAL ESTATE VALUATION PROCESS,” each of which are hereby incorporated herein by reference in their entirety for all that they teach and for all purposes.

### BACKGROUND

In general, real estate valuation is the process of valuing certain real property based on a number of estimation factors. These estimation factors can include general and/or specific valuation considerations. Examples of general valuation considerations may include market conditions, cost of living, inflation, employment rate, consumer price index, and the like. Specific valuation considerations may relate to the real property that is the subject of the valuation, or subject property. Among other things, the value of a subject property can be affected by location (e.g., address, zoning, distance to other sites, etc.), condition (e.g., aesthetic, functional, etc.), specifications (e.g., area, rooms, baths, construction type, size, shape, etc.), characteristics (e.g., geographical orientation, age, improvements, appliances, etc.), neighborhood, comparable properties, sale prices, market prices, and/or any adverse conditions associated therewith.

Further complicating real estate valuation is the use of different valuation approaches by valuation agents including various techniques, standards, forms, and/or processes to name a few. In some cases, these valuation approaches may be dictated by a specific group, company, lender, broker, federal entity, combinations thereof, and the like. For instance, a comprehensive valuation may require a valuation agent to enter the subject property, determine specific valuation considerations relating to the subject property, and even find nearby/recent values for a number of comparable properties (e.g., within a certain distance, or standard range, from the subject property). A quick, or drive-by, valuation may only require a cursory observation of the subject property (e.g., without entering the subject property) and one or more comparable properties that may fall outside of the certain distance, or standard range, from the subject property.

As can be appreciated, each of the valuation approaches may employ different valuation forms to record information gathered in a real estate valuation. One example of a valuation form is the Uniform Residential Appraisal Report (“URAR”), or Form 1004, created by the Federal Housing Finance Agency via the Federal National Mortgage Association (“FNMA”). Other examples of forms can include the Small Residential Income Property Appraisal Report (“Form 1025”), the Exterior-Only Inspection Residential Appraisal Report (“Form 2055”), Broker Price Opinion (“BPO”) forms, Commercial Property Valuation Form, Agricultural Valuation Form, and the like. In some cases, the forms (e.g., BPOs, etc.) can vary in content, layout, and presentation depending on who the form is designed by and/or for (e.g., from broker to broker, etc.).

Because each valuation agent, broker, lender, agency, company, and/or other entity may implement their own processes rules and/or data requirements, new or modified versions of the forms are required to be processed by skilled programmers to implement the various forms. The efforts of the programmers in developing these forms represent a significant investment in time, equipment, and money.

### SUMMARY

It is with respect to the above issues and other problems that the embodiments presented herein were contemplated. In general, embodiments of the present disclosure provide methods, devices, and systems by which valuation agents may prepare valuation reports for real property. In some embodiments, the valuation may be prepared for industrial, commercial, and/or residential real estate. Additionally or alternatively, the valuation processes disclosed herein may be utilized in connection with Broker Price Opinions (“BPOs”) and/or appraisals. Furthermore, some or all of the processes disclosed herein can also be utilized in other valuation processes such as auditing, for example.

One embodiment of the present disclosure is directed to automatic and intelligent form building. Generally, the prior art systems for obtaining and completing real estate valuations requires a significant level of customization of forms and processes. A governmental or quasi-governmental agency, such as the Department of Housing and Urban Development (“HUD”), the Federal Housing Finance Agency (“FHFA”), FreddieMac, or FannieMae, set certain requirements for valuations. One set of requirements is the Uniform Appraisal Dataset (“UAD”). However, within the requirements set by these governmental or quasi-governmental agencies, various users, including but not limited to, valuation agents, service providers, and the consumer of valuation products and services (e.g., customers, etc.) may each implement their own processes, rules, and data requirements. Prior art systems required new or modified forms and processes to be developed by skilled programmers and represent a significant investment in time, equipment, and money.

Benefits of the embodiments described herein result in the timely development of forms and workflows with reduced errors caused by inaccurate data and poor quality control. Additional benefits may include increased speed and efficiency with respect to the form and workflow development process. For instance, embodiments of the present disclosure are directed to a method for reviewing a valuation to perform quality checks on submitted valuation reports. In particular, the processes disclosed herein create efficiencies in the creation of a report as well as maximize the quality of the report. Furthermore, the processes disclosed herein reduce time and costs associated with report completion.

In one embodiment, a software as a service (“SaaS”) is provided. In other embodiments, a locally-hosted server may provide some or all of the features described herein. Data, rules and workflows are partitioned to prevent access of private information to unauthorized parties. Users (e.g., valuation agents, providers, customers, etc.) can access the service via a web browser and/or an application. By way of example, users may create assignments, cancel or change assignments, monitor progress, and receive reports. Users may develop custom forms, define rules for assignments, monitor workloads, and quality check valuations. Additionally or alternatively, one or more of the users may receive assignments, enter valuation data, be presented with additional information or error messages, and submit valuations. A custom form may be specified by one or more of the users along with the associated workflow for the form.

The valuation industry uses a number of forms. Property type, land use, valuation purpose and business need are examples of forms. Individual users may also have their own variations of these forms. As a result developing forms in the prior art is complex and burdensome.

In addition to industry and legal requirements, branded options provide a form development tool library utilizing the customer's terminology, data requirements and workflows. A user of the forms and rules, such as a valuation agent, can be presented with overall and property-specific workflows. A property-specific workflow includes the individual steps required to complete the valuation. Among other things, steps may be summarized and an indicator (e.g., a color code, an identifier, a symbol, progress bar, combinations thereof, etc.) may provide information to the user regarding which steps/fields of the workflow are complete, incomplete, and/or contain errors.

One embodiment of the present disclosure is directed to methods and systems for guided and intelligent valuation work flow in completing any type of valuation form. In some embodiments, as the user completes the form, inline assistance may be provided to inform the user of helpful tips or to highlight areas of caution, such as known areas of potential errors. Validation rules can execute upon an individual data field input, or groups of inputs, as determined by the rules. Inline assistance may be associated with input with a specific field (e.g., a telephone number contains too few digits, etc.) or associated with one or more additional values input into the form or from another source (e.g., the number of bedrooms cannot be more than the total number of rooms, etc.). The user may then be informed of the error, asked to confirm the information, and/or other measure as required by the rules (e.g., obtain secondary review, etc.). The rules that are analyzed by this inline assistance may include field-format rules, business rules, complex business rules and the like. Examples of field-format rules include ensuring that the value input into a field complies with the appropriate format for the field (e.g., a date field may require MM/DD/YYYY as an input format). Examples of complex business rules may include bracketing rules where a subject property is required to have comparative properties bracketing the subject property (e.g., the estimated value of the subject property should have a comparable property with a larger estimated value and another comparable property with a smaller estimated value).

Error indicators, such as color highlighting, may provide a readily discernible indicator to the user of the location on the form which may be out of compliance. Additional information such as fly-over help, message boxes, tool-tips, and the like provide information as to why the value is in error and/or cues on how to remedy the error.

A historical file may be maintained. As valuations progress, individual inputs, groups of inputs, and/or complete valuations may be tracked. One advantage of tracking individual inputs is the determination of a valuation agent performance. As an example, a valuation agent with an incomplete appraisal, due to an error, may change a value to remove the error. The change performed may simply correct a mistake or it may be an attempt to complete the appraisal without regard to the accuracy of the information. This input, among others, may be recorded and the performance of the valuation agent may be based, at least partially, on the recorded input. It is anticipated that a valuation agent may be associated with a quality score based on the valuation agent's performance. As can be appreciated, valuation work orders may be selectively directed to one or more valuation agent based on the valuation agent's quality/performance score.

It may also be desirable to maintain historical work files for future access and/or auditing purposes. In particular, all of the data entered by a valuation agent may be stored in a database even though only a subset of the data entered is used to populate a valuation form. The historical work file may contain all of the data that was entered by the valuation agent and/or used by the valuation agent to justify the valuation of a subject property. Access to the historical work file may be controlled by encryption and/or password protection mechanisms.

Forms completed by the processes described by the embodiments herein may be printed, published, and/or stored as standardized forms. In such embodiments, data from an online form may be mapped to paper forms (or paper equivalent electronic forms) for automatically completing such forms.

Automated workflows provide users with one or more of work order assignment notifications, overdue notices, follow-up instructions, and the like. Users placing/generating valuation work orders may enter their user interface, retrieve documents, add notes, edit work orders, check statuses, cancel assignments, and/or add new assignments. New work order assignments may be entered individually or bulk uploaded. By way of example, work orders may be entered into a valuation application on a valuation server via a Microsoft® Excel® spreadsheet file, a data file, etc. In some embodiments, the management of work orders may be performed by pooling specific work orders and managing the pooled specific work orders as a group.

In one embodiment, the valuation work orders may be monitored for changes in data, accuracy, state of completion, progress, time accessed, and/or the like. Monitoring may be performed in real-time via a dashboard or by various automatic and/or on-demand reports.

In another embodiment, quality control rules can be automatically selected and applied to help ensure workflows are executed completely and accurately as defined by a user, agency, and/or customer-defined criteria. Selection may be made in association with file metadata and/or the rules themselves may be included in file metadata.

In another embodiment, a form development tool is provided for the development of compliant forms supporting customized processes and information. A metadata-based architecture provides flexibility for users to design and automatically generate customized documents and products. A catalog of reusable standard and custom data points is provided for easy use, and reuse. A library of forms and product definitions is provided for use or expansion to support expanding business needs. Forms may be exported and generated in proprietary and/or standard formats, such as the Portable Document Format (“PDF”), EXtensible Markup Language (“XML”), and/or Hypertext Markup Language (“HTML”), to name a few. Additionally or alternatively, a customizable rules engine may provide the standard and customized forms with customer- and product-specific behavior and attributes.

In one embodiment, forms may be developed with the benefit of data profiles. Data profiles can include elements from the catalog of UAD-compliant data points, rules and behaviors for each field, groups of fields and/or forms. Data points may also be mapped to existing forms, such as PDF forms and the like.

In some embodiments, the form building libraries may be classified with an identifier. A property type (e.g., commercial, residential, agricultural, etc.) and/or purpose type (e.g., valuation, inspection, appraisal, audit, etc.) may describe the classification. The classification can determine an available catalog of data points. Groupings of data points provide common and/or previously customized data fields that the user can select and optionally customize to build the reusable data profile.

Additionally, forms may have an associated workflow. The workflow may be specific to types of users, such as valuation agents, providers, customers, reviewers, etc.

A user may build a form by executing an easy to follow interface. In one embodiment, a user may first select a type of property and the type of valuation work to be performed. The user may then be presented with a catalog of both generic and UAD-compliant data fields (e.g., subject property address, subject property contract date, comparable property address, etc.), such as in an XML format. Forms may be built via a drag-and-drop interface or selected from various lists. The rules and workflows may then be further customized. The result is a complete product which then may be published so that it is available for use. A product manager interface allows for the building of the forms and/or modification of existing forms. In some embodiments, a product is different from a form. In particular, a form may correspond to a particular output desired for valuation data whereas a product corresponds to a form in addition to other requirements related to the delivery of the form (e.g., order data requirements, client name, Service Level Agreement (SLA), costs associated with delivery of the product, revenues associated with delivery of the product, etc.). A product manager may operate separately and distinctly from the form builder that is used to generate new forms. In particular, the product manager may enable a user to define which forms are available to be included in certain products, for example.

The storage of the data is variously embodied. In one embodiment, metadata is implemented, such as XML, to define data fields, rule components, complete rules, and presentation appearance.

The implementation of the rules is also variously embodied. In one embodiment, schema items or attributes store the rules. Rules may contain literal values, estimated values, simple operations and/or complex operations. Additional rule embodiments include type casting, rule parser syntax, operators, attributes, and field filters.

In another embodiment, a quality control engine (e.g., a valuation monitor, etc.) is provided. Timelines and certain field rules may be evaluated at a later date, as opposed to indicating an error at the time of entry. Optionally, additional services, such as geolocating services, may be utilized to verify information and/or as a source of select information.

The execution of a workflow may be managed through a work organizer, or management module. Rules associated with the assignment of work (e.g., round robin, highest rating, preferred, etc.) may be selected. The workflow may trigger a notification to a user of the project by an entry on the user's dashboard, email, text message, voice message, and/or other means. Production rules can provide updates and performance measurements (e.g., performance of valuation agents, etc.). Time-based events, such as a missed deadline, may result in the cancellation of the assignment or automatic reassignment to another user. The work organizer management tools may monitor individual or aggregate user performance to measure workload and may even estimate a predicted workload for future timeframes.

Embodying one or more of the foregoing solutions in a “cloud” based solution is contemplated herein. A user may access authorized functions via a thin client and web interface and/or application. One or more memories/databases can provide the user with access to their particular interfaces and/or data. Test platforms may be provided to enable the development of rules, forms, and/or workflows to be executed in a test environment. Upon successfully completing the testing phase, the rule, form, and/or workflow may then be published to a valuation, or production, server where it is made available for use.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “comparable property” or “comp” and variations thereof, as used herein, refers to any real property that is used to aid in the valuation of a subject property. Comparable properties may have one or more characteristics that are similar to those of the subject property. Such characteristics may include, but are not limited to, location, price, area, shape, design, condition, improvements, neighborhood, region, adjoining parcels, easements, combinations thereof, and/or any adverse conditions associated therewith.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “subject property” as used herein refers to the real property for which a valuation is ordered, prepared, and/or submitted.

The term “valuation” as used herein refers to a recorded estimation of the worth associated with real property. Valuation can include, but is not limited to, one or more of an appraisal, audit, price opinion (e.g., BPOs, etc.), real estate value estimate, and the like. It should be appreciated that the valuation can include an assessed value, or price, associated with a specific property. The real property can be associated with at least one type of property including, but is not limited to, residential, commercial, agricultural, government, and/or other types of land.

The term “valuation agent” as used herein refers to any agent involved in performing, reviewing, and/or ordering a valuation of a subject property. Valuation agents may include, but are not limited to, appraisers, brokers, real-estate agents, individuals, groups, and/or companies.

The term “valuation score” as used herein refers to how closely a comparable property matches a subject property for the purposes of valuation. The valuation score can provide a numerical, and/or other, value (e.g., color code, phrase, symbol, etc.) to indicate how close the comparable property matches valuation characteristics of the subject property. Such valuation scores can be based on a range, or percentage, having a lower limit and an upper limit (e.g., from “0” to “100,” respectively). Valuation scores of comparable properties may include any value between, and/or including, the lower and upper limits. It should be appreciated that a valuation score of at least one comparable property may be compared with the valuation score of another comparable property to determine which comparable property best represents a similarity of characteristics with the subject property.

### BRIEF DESCRIPTION OF THE DRAWINGS

The present disclosure is described in conjunction with the appended figures:

FIG. 1A is a first overhead map of a subject property in an environment in accordance with embodiments of the present disclosure;

FIG. 1B is a second overhead map of a subject property in an environment in accordance with embodiments of the present disclosure;

FIG. 2 is a block diagram of a valuation system in accordance with embodiments of the present disclosure;

FIG. 3 is a representation of a graphical user interface of a valuation work flow in accordance with embodiments of the present disclosure;

FIG. 4A is a representation of a first graphical user interface of a valuation application in accordance with embodiments of the present disclosure;

FIG. 4B is a representation of a second graphical user interface of a valuation application in accordance with embodiments of the present disclosure;

FIG. 5 is a representation of a consolidated data section of a valuation application in accordance with embodiments of the present disclosure;

FIG. 6A is a representation of a third graphical user interface of a valuation application in accordance with embodiments of the present disclosure;

FIG. 6B is a representation of a fourth graphical user interface of a valuation application in accordance with embodiments of the present disclosure;

FIG. 7 is a representation of a standard valuation form mapped to fields of the valuation application in accordance with embodiments of the present disclosure;

FIG. 8 is a flow diagram depicting a method of pushing a valuation work order to valuation agents in accordance with embodiments of the present disclosure;

FIG. 9 is a flow diagram depicting a method of populating a digital valuation form with retrieved valuation data in accordance with embodiments of the present disclosure;

FIG. 10 is a flow diagram depicting a method of creating a digital valuation form in accordance with embodiments of the present disclosure;

FIG. 11 is a flow diagram depicting a method of monitoring data associated with a digital valuation form in accordance with embodiments of the present disclosure;

FIG. 12 is a flow diagram depicting a method of converting digital valuation form data into a valuation form in accordance with embodiments of the present disclosure;

FIG. 13 is a flow diagram depicting a method of converting input received at a digital valuation form into multiple types of standard valuation forms in accordance with embodiments of the present disclosure;

FIG. 14 is a block diagram depicting a presentation framework and methods of delivering data to a valuation agent in accordance with embodiments of the present disclosure;

FIG. 15 is a block diagram depicting an inheritance model used for building and updating forms in accordance with embodiments of the present disclosure;

FIG. 16 is a flow diagram depicting a quality control method in accordance with embodiments of the present disclosure;

FIG. 17 is a flow diagram depicting a method of storing historical valuation work in addition to delivering forms in accordance with embodiments of the present disclosure; and

FIG. 18 is a flow diagram depicting a method of applying custom workflows to products and/or clients in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

FIG. 1 shows an overhead map 100 of a subject property 104 in an environment in accordance with embodiments of the present disclosure. Although shown as an area having streets 108, roads 112, a highway 116, recreational areas 120, 132a-b, educational areas 124a-c, buildings 128, retail area 140, an industrial area 136, and other features, it should be appreciated that the environment may be any area having a subject property 104. In other words, the environment may comprise residential, commercial, agricultural, combinations thereof, and other zones.

In some embodiments, the location of the subject property 104 may affect a valuation associated with that subject property 104. For instance, a property located close to a lake 120 or primary school 124 may be considered more valuable than a property located adjacent to an industrial area 136. Other negative location factors can outweigh certain location benefits. By way of example, a property may be located adjacent to a school 124c, which may suggest be a location benefit, but that same property may also be located close to a major highway 116. As can be appreciated, the negative location factors associated with the major highway 116 may counteract at least a portion of the location benefit associated with the school 124c. Additionally or alternatively, conditions surrounding the location of a subject property may affect value including, but not limited to, view, noise, neighborhood condition, traffic, easements, and the like.

As shown in FIG. 1, the subject property 104 is located in a region 144 bounded by three roads 112, namely roads “30,” “70,” and “85.” The subject property 104 is further located on at least one street 108 within this region 144. Moreover, the subject property 104 shown is located close to two recreational areas 132a-b. Examples of recreational areas may include, but are not limited to, parks, recreational centers, playgrounds, natural features, wilderness areas, government protected land, manmade features, and other areas configured to support recreational activities.

FIG. 1B shows a close-up view of the region 144 surrounding the subject property 104. In preparing a valuation of a subject property 104 the location and/or condition of comparable properties 160a-i may be considered. The various comparable properties 160a-i shown in FIG. 1B may be located at one or more distances from the subject property 104. In some embodiments, comparable properties 160a-i may be required to be selected within a certain distance from the subject property. In other words, depending on various valuation quality control standards and/or rules, comparable properties 160a-i may be excluded from consideration and/or use based on their distance from the subject property 104. These distances may be expressed as one or more zones 150-158 having an area at least partially surrounding the subject property 104. By way of example, a first zone 150 may represent a circle having a radius that is equal to the maximum qualifying comparable distance for a particular standard and/or rule. Continuing this example, any comparable properties 160a-c within this first zone 150 can be used in a valuation of the subject property 104. As such, the particular standard may define that any properties located outside the first zone 150 (e.g., comparable properties 160d-i) cannot, or should not, be used for valuation purposes.

In some embodiments, multiple valuation standards may exist that specify different distances from the subject property 104 to qualify as a usable comparable property. For instance, a first standard may state that comparable properties 160a-c located within an area comprising a first distance from the subject property 104, shown by the first zone 150, may be allowed for valuation purposes. A second standard may state that comparable properties 160a-e which are located within an area comprising a second distance from the subject property 104, shown by second zone 154, may be allowed for valuation purposes. A third standard may state that comparable properties 160a-g which are located within an area comprising a third distance from the subject property 104, shown by third zone 158, may be allowed for valuation purposes. In some cases, a specific standard may not be used in valuations, and any comparable property 160a-i, even those found outside of the third zone 158 may be used in valuations.

In accordance with embodiments of the present disclosure, a valuation agent may select a particular standard to find one or more comparable properties 160a-i that are allowed for valuation purposes by the particular standard. For example, the valuation agent may select the strictest standard (e.g., the standard requiring the closest distance from the subject property 104, etc.) to find comparable properties 160a-c. Additionally or alternatively, it is anticipated that valuations prepared in accordance with one or more standards may be certified as being in compliance with the one or more standards. This certification may be indicated on at least one of the valuation forms prepared by the valuation agent.

Similar to the location of the subject property 104 as provided above, the location of the comparable properties 160a-i may affect a valuation associated with each of the comparable properties 160a-i. Additionally or alternatively, a comparable property 160a-i may be used and/or rated based on a similarity of characteristics with the subject property 104. For instance, if the subject property 104 is located close to a lake 120 or recreational area 132a, the ideal comparable properties 160a-i should be located close to a lake 120 or recreational area 132a, b. When a comparable property 160a-i includes similar characteristics to the subject property, the comparable property 160a-i may be assigned a high valuation score. For example, a comparable property 160a-i may include similar, if not identical, characteristics to the subject property 104. In this example, the valuation score may be close to the upper limit of the score range (e.g., a score of 80 or above, etc.).

Referring now to FIG. 2, a block diagram of a valuation system 200 is shown in accordance with at least some embodiments of the present disclosure. The valuation system 200 may be a distributed system and, in some embodiments, comprises a communication network 204 connecting one or more communication devices 208 with a valuation server 216. In some embodiments, the valuation server 216 may provide cloud-based services to the communication devices 208. Additionally or alternatively, the valuation server 216 may be configured to retrieve information from one or more valuation data sources 268. In some embodiments, the valuation server 216 may present map information to a communication device 208 provided via a map server 256.

In accordance with at least some embodiments of the present disclosure, the communication network 204 may comprise any type of known communication medium or collection of communication media and may use any type of protocols to transport messages between endpoints. The communication network 204 may include wired and/or wireless communication technologies. The Internet is an example of the communication network 204 that constitutes an Internet Protocol (IP) network consisting of many computers, computing networks, and other communication devices located all over the world, which are connected through many telephone systems and other means. Other examples of the communication network 204 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 204 need not be limited to any one network type, and instead may be comprised of a number of different networks and/or network types. Moreover, the communication network 204 may comprise a number of different communication media such as coaxial cable, copper cable/wire, fiber-optic cable, antennas for transmitting/receiving wireless messages, and combinations thereof.

The communication devices 208 may correspond to web-enabled user communication devices. In accordance with at least some embodiments of the present disclosure, the communication devices 208 may comprise any type of known web-enabled communication equipment or collection of web-enabled communication equipment. Examples of a suitable communication device 208 include, but are not limited to, a personal computer, laptop, tablet, Personal Digital Assistant (PDA), smart phone, or combinations thereof. In general each communication device 208A-N may be adapted to support video, audio, text, and/or data communications with other communication devices 208 as well as the valuation server 216 and/or other devices 256, 268, 270. The communication devices 208 may include one or more of a processor, memory, camera sensor, location service, geographical location transceiver, web browser, display screens, application programming interface, combinations thereof, and the like. The type of medium used by the communication device 208 to communicate with other communication devices 208A-N and/or other devices 256, 268, 270 may depend upon the communication applications available to the communication device 208.

In accordance with at least some embodiments of the present disclosure, a user may utilize their communication device 208 to access a valuation server 216 and one or more valuation applications 240. In one embodiment, the communication device 208 may access the valuation server 216 via a thin client provided via a web-based interface on the communication device 208.

In some embodiments, a valuation server 216 may be included in the valuation system 200. Among other things, the valuation server 216 can provide a communication device 208 with access to one or more valuation features provided by at the valuation server 216. As can be appreciated, the valuation server 216 may include a processor 220 and a memory 224 and/or communicate with a memory 270 across a communications network 204. The processor 220 may comprise a general purpose programmable processor or controller for executing application programming or instructions. In accordance with at least some embodiments, the processor 220 may include multiple processor cores, and/or implement multiple virtual processors. In accordance with still other embodiments, the processor 220 may include multiple physical processors. As a particular example, the processor 220 may comprise a specially configured application specific integrated circuit (ASIC) or other integrated circuit, a digital signal processor, a controller, a hardwired electronic or logic circuit, a programmable logic device or gate array, a special purpose computer, or the like. The processor 220 generally functions to run programming code or instructions implementing various functions of the valuation server 216.

The valuation server 216 may be configured to receive a request for resources/features from a communication device 208. Access to the various resources/features of the valuation server 216 may be controlled by a work organizer 228 and/or other module of the server. In some embodiments, the valuation server 216 may grant and/or deny access based at least partially on identification information provided by the communication device 208. The identification information may be stored in one or more memory 224, 232, 270 of the system 200. In some embodiments, the access may be controlled by the processor 220 comparing identification information provided by the communication device 208 to identification stored in a memory 224, 232, 270.

The valuation server 216 may include one or more valuation modules 228, 232, 236 and/or valuation applications 240. In accordance with embodiments of the present disclosure, the valuation server 120 may include a work organizer module 228. The work organizer module 228 may control access to at least one of work orders, valuation applications 240, and/or stored data. Additionally or alternatively, a user may create one or more valuation work order by accessing the work organizer 228 and providing specific valuation work order information. Examples of valuation work order information may include, but are not limited to, subject property 104 address, valuation type, requested valuation agent, timeframe for valuation, linked valuation data, requested valuation agent qualifications and/or performance, combinations thereof, and the like.

For instance, a user may generate a valuation work order that requires a full URAR valuation of a subject property 104 in accordance with Uniform Standards of Professional Appraisal Practice (“USPAP”) quality control standards. In this example, the work organizer 228 may determine and/or request additional valuation information, as described herein. Among other things, the work organizer 228 may retrieve information from one or more valuation data sources 268. This information may be entered into a template by the work organizer 228 and presented to one or more valuation agents via notification. In some embodiments, the notification may be pushed to one or more communication devices 208 via the work organizer 228.

In some embodiments, the work organizer 228 may store valuation work orders in a project memory 232 associated with the valuation server 216. The project memory 232 may include individual work orders, groups of work orders, work order templates, maintain a standards database, rules, and other data corresponding to valuations.

In some embodiments, a communications feature module 128 may be used to determine one or more communications features that are associated with a communication session. In one embodiment, the communications feature module 128 may determine one or more communications features to be used in a scheduled communication session. In other words, the communication session does not need to be established before the communications features can be determined by the communications feature module 128.

The rules engine 236 may provide one or more forms with various behavior and attributes. In one embodiment, the rules engine 236 may be customizable. In this case, the rules engine 236 may provide standard and/or customized forms with user-specific behavior and attributes. For instance, the standard and/or customized forms may be developed with the aid of data profiles. These data profiles may be stored in the project memory 232 or other memory 224, 270 of the system 200. The data profiles can include data points, rules, and/or behaviors for each field in a form, groups of fields in a form, and/or forms. As can be appreciated, the data points may be mapped to one or more fields, groups of fields, and/or forms. The rules engine 236 may serve to logically arrange one or more fields in a custom digital valuation form to be presented to a user. This logical arrangement of fields may differ from the arrangement of fields on a standard (i.e., non-custom and/or non-digital, etc.) form. It is one aspect of the present disclosure that the logical arrangement of fields in the custom digital valuation form allows for comprehensive and grouped valuation data collection.

In some embodiments, the system 200 may include a memory 224, 232, 264, 270. Among other things, the memory 224, 232, 264, 270 may be used to store instructions, that when executed by a processor of the system 200, perform the methods as provided herein. In some embodiments, one or more of the components (e.g., communication device 208, valuation server 216, map server 256, valuation data source 268, etc.) of the system 200 may include a memory 224, 232, 264, 270. In one example, each component in the system 200 may have its own memory 224, 232, 264, 270. Additionally or alternatively, the memory 270 may accessed by each component in the system 200. In some embodiments, the memory 270 may be located across a communication network 204 for access by one or more components in the system 200. In any event, the memory 224, 232, 264, 270 may be used in connection with the execution of application programming or instructions by the processor, and for the temporary or long term storage of program instructions and/or data. As examples, the memory 224, 232, 264, 270 may comprise RAM, DRAM, SDRAM, or other solid state memory. Alternatively or in addition, the memory 224, 232, 264, 270 may be used as data storage and can comprise a solid state memory device or devices. Additionally or alternatively, the memory 224, 232, 264, 270 used for data storage may comprise a hard disk drive or other random access memory. In some embodiments, the memory 224, 232, 264, 270 may store information associated with a user, access, permissions, credentials, valuation data, a timer, a device, rules, and the like. For instance, the memory 224, 232, 264, 270 may be used to store access information associated with one or more communication devices 208 of the system.

The valuation server 216 may include one or more valuation applications 240. In some embodiments, a valuation application 240 may include one or more modules 244, 248, 252 configured to provide valuation functions associated with the valuation server 216. One example of a valuation application 240 may include a form module 244, an error module 248, and a valuation monitor 252, to name a few. Although the work organizer 228 and the rules engine 236 are shown separate from the valuation application 240, it is anticipated that embodiments of the present disclosure should not be so limited. In one embodiment, the work organizer 228 and the rules engine 236 may be part of the valuation application 240.

In some embodiments, the form module 244 may comprise instructions that, when executed by a processor, generate, modify, and/or convert data for use in one or more forms. It is an aspect of the present disclosure that the form module 244 generates a custom digital valuation form. This digital valuation form may be accessed by a user in recording valuation data. Additionally or alternatively, the form module 244 can convert data recorded in the digital valuation form to one or more standard forms (e.g., company-specific, government-created, customer-specific, paper-based, and/or industry-specific, forms, etc.). One example of a standard form is the Uniform Residential Appraisal Report (“URAR”), or Form 1004.

The form module 244 may operate alone, or in conjunction with the rules engine 236, to map fields of the digital valuation form to the standard, customer-specific, and/or industry-specific forms. By way of example, once a valuation is complete, the form module 244 can convert the data stored in the digital valuation form to one or multiple different formats.

An error module 248 may determine whether valuation data conforms to one or more standards, forms, practices, rules, and the like. It is anticipated that the error module 248 may periodically and/or continually monitor a valuation for errors associated with data entry, collection, and/or accuracy. In some embodiments, the error module 248 may present information to a user, via a communication device 208, regarding the any errors detected. This information may include inline assistance to assist the user in correcting and/or addressing the detected error. For instance, the error module 248 may provide at least one of a tip, format an area, highlight a field, and/or provide some other indicator to a user related to a detected error.

It is anticipated that the error module 248 may review data contained and/or stored in a digital valuation form prior to preparing a standard form. For example, a user may be required to submit a valuation using a comprehensive valuation form (e.g., Form 1004, etc.), but the user may have only collected a minimal amount of data in the digital valuation form in anticipation of providing an abbreviated valuation. The user may be alerted that the data collected will not satisfy the requirements associated with the comprehensive valuation form. This alert may be provided by the error module 248 automatically (e.g., via continual monitoring, etc.), in response to receiving a conversion input, and/or in response to receiving a “save form” input (e.g., where the user selects to save the valuation data collected in a standard form, etc.).

In some embodiments, the valuation server 216 may include a valuation monitor module 252. The valuation monitor module 252 can be configured to periodically check valuation information associated with a valuation work order, a subject property 104, a comparable property, at least one valuation data source 268, combinations thereof, and the like. In one embodiment, the valuation monitor 252 may receive notifications of changes to data from one or more other components of the system 200. For instance, a valuation may be made by a user at a first point in time when the list prices of comparable properties are set at a certain value. In the event that the list prices change, the valuation monitor 252 may update the digital valuation form to include the change. In some embodiments, the valuation monitor 252 may alert a user working on a valuation of the change. Additionally or alternatively, the valuation monitor 252 may determine whether the valuation is valid based at least partially on the changed valuation data monitored.

The system 200 may include access to a map server 256, or service. Among other things, the map server 256 may present maps of locations to the communication device 208 of a user. The maps may be used to determine the location of a subject property 104, establish one or more comparable properties 160a-i, valuation characteristics, and/or determine the location of a valuation agent relative to a subject property 104. The map server 256 may include a location module 260. The location module 260 can be provided to utilize location information (e.g., satellite position, Wi-Fi hotspots, cell tower data, IP addresses, and the like) associated with a communication device 208 of a user. This location information may be presented on a map of the area. Additionally or alternatively, the location information may be reported to the valuation server 216, and even the work organizer 228. In some embodiments, the work organizer may distribute work orders based on this location information. The map server 256 may include a memory 264. The memory 264 may be configured to store information relating to maps, locations, and/or users. In one embodiment, the memory 264 may include a database of map features, map information, historical map data, etc.

The valuation server 216 may receive valuation data from one or more valuation data sources 268. Examples of valuation data sources 268 may include, but are not limited to, the Multiple Listing Service 268A (“MLS”), public records information 268B (e.g., recording office data, county clerk data, federal housing information, recorded easements, etc.), private record valuation information 268N (e.g., proprietary valuation data, real-estate records, paid-for services, etc.). As described herein, the valuation server 216 may automatically populate digital valuation forms with data obtained from the one or more valuation data sources 268. The valuation data may be automatically retrieved from the one or more valuation data sources 268. For instance, upon creating a valuation work order for a specific subject property 104, the valuation server 216 may request valuation information (e.g., sale prices, comparable information, property area, size, design, recorded easements, address particulars, neighborhood information, etc.) from the one or more valuation data sources 268. Additionally or alternatively, the valuation data may be pulled from the one or more valuation data sources 268 via a user selection, for example.

FIG. 3 is a representation of a graphical user interface (“GUI”) displaying a valuation work flow 300 in accordance with embodiments of the present disclosure. Although shown in a GUI format, it should be appreciated that the valuation work flow 300 may represent a number of work items 320 to be completed in a given order. For instance, the valuation work flow may include various sections that can be completed from top to bottom (e.g., from first work group 308A to second work group 308B, etc.) as presented. The valuation work flow 300 may include at least one of a header section 304, first work group 308A, a second work group 308B, and one or more fields and/or sections 328.

The header section 304 may include GUI controls 310, a highlight work identifier 312, and a status indicator 316. As can be appreciated, the GUI controls 310 may be used to minimize, maximize, resize, and/or close the valuation work flow 300. In some embodiments, one or more of the work sections 320 displayed in the first and/or second work groups 308A-B may be selected. When selected, an identification of the selected work section 320 may be indicated in the highlighted work identifier 312. The selection may be made automatically, via the valuation server. In some embodiments, the selection of a work section 320 may be made by a user. Among other things, the identifier 312 may serve to alert a user as to which work section, if any, is selected. The highlighted work identifier 312 may include a color, shading, name, symbol, code, number, and/or combinations thereof to identify the selected work section.

In some embodiments, the header section 304 may include a status indicator 316. The status indicator may be arranged to visually represent at least one of a completion amount associated with the valuation work order, a completion level associated with a particular form, a completion level associated with a work section 320, and a completion level associated with a work group 308A-B. In one embodiment, the status indicator 316 may be arranged as horizontal bar, where a level of completion can be indicated by the size, or length, of the bar and/or a portion of the bar. For example, as a work flow is started, the bar and/or the portion of the bar may have a minimal size and/or length. As the work flow nears completion, the bar and/or the portion of the bar may grow (i.e., increase in dimension) to indicate a level of completion and/or a percentage of completion of the various parts of the valuation work flow 300. As can be appreciated, a user may quickly evaluate a percentage of completion by observing a dimension of the bar and/or the portion length. The status indicator 316 may occupy a portion of the header section 304 or span an entire length of the header section 304.

In one embodiment, the status indicator 316 may include a percentage of completion. This percentage of completion can be displayed as at least one of a number, color, code, and the like. For example, and as shown in FIG. 3, the status indicator 316 displays a “25%” level of completion. In some cases, this percentage can relate to the overall completion of the valuation work flow 300, a work group 308A-B, a work section 320, and the like. In accordance with some embodiments of the present disclosure, the status indicator 316 may include combinations of visual representations of progress. For instance, the status indicator 316 may incorporate a horizontal bar and a percentage displayed.

The first work group 308A may include one or more work sections 320. In some embodiments, the work sections 320 may represent various sections of a valuation work order. For instance, the work sections 320 may include, but is not limited to, overall scope, data import, market data, valuation form, photos, addenda, review, and the like. In some cases, each of the work sections 320 may include a link to a section of a digital valuation form. When a work section 320 is selected, the link may be resolved, and the user may be directed to a section of the digital valuation form.

In some embodiments, each work section 320 may include a visual identifier 324. The visual identifier 324 may be used to indicate a status of the work section 320. The status may include at least one of a completion level, a valuation data source 268 associated with the data contained in the work section 320, and the like. In one embodiment, the visual identifier 324 may be color-coded to indicate the status of the work section 320. For instance, in the event that the work section 320 is not complete, the color may indicate a level of completion. Continuing this example, a totally incomplete work section 320 may provide no color via the visual identifier 324 to indicate that the work section includes no valuation data. As another example, if the work section 320 is partially complete, the color may change in the visual identifier 324 to partially complete color (e.g., yellow, etc.). As yet another example, if the work section 320 is totally complete, the color of the visual identifier 324 may change to a fully complete color (e.g., green, etc.).

In one embodiment, the visual identifier 324 may be color-coded to indicate that data included in a particular work section 320 has been entered and/or retrieved from a valuation data source 268. For instance, when a work order is generated and the valuation work flow 300 is created, the valuation server 216 may retrieve information from one or more of the valuation sources 268. When the data is retrieved from one or more valuation data sources 268, the visual identifier 324 may provide a color different from one or more of the colors previously described in conjunction with level of completion associated with a work section 320. In some cases, the colors disclosed herein may vary in intensity, transparency, fill level, shading, animation, combinations thereof, and the like.

The second work group 308B may include one or more work sections 320 that are restricted from selection based on one or more of error checking, completion level, and authorization. The color, shading, and/or presentation of the second work group 308B may reflect that the various work sections 320 are restricted. In one example, the work sections and/or fields associated with the second work group 308B may be greyed-out, invisible, and/or inaccessible by a user. By way of example, the second work group 308B may include a “Signature Page” and/or an “Assemble/Send” work section. Continuing this example, the work sections in this group 308B may only be completed after the valuation work flow is completed. It is anticipated that once the valuation work flow has reached the appropriate level of completion (e.g., all required sections are complete, each section is complete, and/or authorization is granted, etc.) the work sections in the second work group 308B may be selected. In other words, any restrictions may be removed. In some embodiments, when restrictions on one or more work sections in the second work group 308B are removed, the one or more work sections may move into the first work group 308A.

FIGS. 4A and 4B depict various embodiments of a market data tab 412 of a valuation application GUI 400. The GUI 400 may include a valuation identifier 404, one or more tabs 408 (e.g., representing valuation form sections, work flow sections, etc.), a subject property group 432, and a map area 438. The valuation identifier 404 may identify the valuation work order, the subject property 104, valuation application 240, and/or at least one part of the valuation work flow. The tabs can include one or more of a market tab 412, a site tab 416, an improvements tab 420, a reconciliation tab 424, etc. In some cases, various tabs may be visible but not selected. As shown these unselected tabs include the site tab 416, the improvements tab 420, and the reconciliation tab 424. In some embodiments, the GUI 400 can include one or more consolidated data sections 440, 480. Each of the consolidated data sections 440, 480 may include valuation data. The valuation data may be manually entered (e.g., via a user at a communication device 208, etc.), retrieved from one or more valuation data sources 268, combinations thereof, and the like.

Each of the tabs 408 may include a tab identifier 428. The tab identifier 428 may be similar to the visual identifier 324 previously described. Among other things, the tab identifier 428 may be used to indicate a status associated with a particular tab 412-424. The status may include at least one of a completion level, a valuation data source 268 associated with the data contained in the tab 412-424, and the like. In one embodiment, the tab identifier 428 may be color-coded to indicate the status of the tab 412-424.

In some embodiments, the GUI 400 may include a scroll bar 460 and scrolling slider 464. The scrolling slider 464 may be used to move portions of the GUI 400 into view of the display area of the GUI 400. As can be appreciated, the GUI 400 may incorporate more than one scroll bar 460 and scrolling slider 464. For instance, although shown as a vertical scroll bar 460, the scroll bar 460 may be horizontal, vertical, and/or combinations thereof.

Referring to FIG. 4A, a representation of a first GUI 400 of a valuation application 240 is shown in accordance with embodiments of the present disclosure. The one or more tabs 408 can include specific valuation work flow sections 320 and/or valuation form sections. For instance, the GUI 400 shows the market data tab 412 selected and market data information displayed to the display area of the window. As shown, the market data tab 412 includes a subject property information group having various subject property fields (e.g., SP Field 1-N). The subject property fields may include, but are not limited to, a subject property address and characteristics (e.g., size, area, shape, MLS number, etc.).

The data filters group 436 can include a number of filters (e.g., Filter 1-N) that can be used to selectively filter data collection provided via the valuation application 240 and GUI 400. In some embodiments, the data filters group 436 may relate to one or more consolidated data groups 440. For example, and as shown in the map area 438, the subject property 104 is shown in a particular market. When the valuation application 240 is used to determine specific market data, such as comparable properties 160a-i, the specific market data may be displayed in a consolidated data group 440. In other words, the comparable properties 160a-i may be displayed in the consolidated data group 440. The data filters in the data filter group 436 may be applied to the data in the consolidated data group 440. For instance, one filter may correspond to a specific comparable zone (e.g., zones 150-158, etc.). Continuing this example, the user may select to search for comparable properties within the first zone 150 by applying the zone filter via the apply filters selection button 448. If the user wishes to apply a different filter, or series of filters, the user can clear any existing filters via the clear filters selection button 444.

In some embodiments, a user may wish to reset all of the data in various sections, groups, and/or fields of the market data tab 412. In this case, the user may select the reset all selection button 452. In some embodiments, selecting this button 452 can reset all of the data contained in the fields relating to select market information. In other words, it is one embodiment of the present disclosure that only the market information may be reset by a selection of this button 452, while the subject property information 432 can remain unchanged.

Once a user has gathered data for valuation in the market data tab 412, the information may be saved to a memory via the save selection button 456. In some cases, selection of the save button 456 may cause the next tab in sequence to be selected. For example, the market tab 412 may be closed and the site tab 416 may be opened. In the event that a user has collected all of the necessary data via the tabs 408, and the save button 456 is selected, the data may be saved into an appropriate standard form. Additionally or alternatively, if the user has collected all of the necessary data via the tabs 408, and the save button 456 is selected, the user may be directed to any incomplete work section of the valuation work flow 300.

In some embodiments, as a user is navigating various tabs 408, groups 432, 436, 440, and/or features associated with the GUI 400, the valuation application 240 may perform dynamic error checking, form filling assistance, data validation, and/or automatic tip presentation. For instance, a user may have been directed by a specific valuation work flow 300, or work order, to use a strict (e.g., first zone 150, etc.) filter for comparable properties 160a-i. Continuing this example, if the user selects a less strict (e.g., second zone 154, third zone 158, etc.) filter for comparable properties 160a-i, the user may be warned via the valuation application 240.

The map area 438 may include a number of tools, buttons, and/or features to aid in defining market conditions for a subject property 104. For instance, it is anticipated that the map area 438 may be moved, panned, zoomed, and/or otherwise oriented to provide a clear image of the subject property 104 and/or any comparable property 160a-i. In one embodiment, a neighborhood, zoning region, and/or other custom area may be defined by selecting the polygonal area button 468.

FIG. 4B is a representation of a second GUI 400′ of a valuation application 240 in accordance with embodiments of the present disclosure. The second GUI 400′ may include one or more buttons to aid in valuation data collection for the market tab 412. These buttons can include, but are not limited to, a use current location button 472, a retrieve market information button 474, and a define neighborhood area button 478.

The use current location button 472 may be employed by a user who is located at a subject property 104. Selecting this button can allow the valuation application 240 to communicate with the user's communication device 208 and gather location information associated with the user's device 208. The location information may be provided by the communication device 208 via one or more of satellite position (e.g., Global Positioning System (“GPS”)), Wi-Fi hotspots, cell tower data, IP address, etc. For example, if a user is located outside of a subject property 104, and selects the use current location button 472 of the valuation application 240, the communication device 208 will provide its location information to the valuation application 240. Continuing this example, the valuation application 240 may provide the user's location information to a map server and update the user's position on the map area 438. From this point, the user may assign the location displayed on the map as the location of the subject property 104.

Once the subject property 104 address is confirmed or selected, the user may select the retrieve market information button 474 to automatically populate market information in various consolidated data groups 440, 480. As can be appreciated, the market information may be retrieved from the one or more valuation data sources 268.

Selecting the define neighborhood area button 478 may provide a neighborhood boundary and characteristics consolidated data group 480. The user may define the metes and bounds of a property, bounding streets, and the like via the consolidated data group 480. In the event the user is defining an area based on directional bounds (e.g., North, South, East, West) a rectangular area may be displayed to the map area 438. Adjustments may be made to the overall shape and/or size of the area by the user via the consolidated data group 480 and/or moving, dragging, reshaping, and/or resizing, the rectangular area displayed to the map area 438.

In one embodiment, the map area 438 of the second GUI 400′ shows a subject property area 482 (e.g., a neighborhood area, etc.). In some embodiments, the subject property area 482 can be defined using the polygonal area button 468. Selecting the polygonal area button 468 may provide a user with polygonal endpoint handles 484 and midpoint handles 488. The user can define the shape of the subject property area 482 by moving and/or dragging the various handles 484, 488. In one embodiment, the endpoint handles 484 may be dragged to define the bounds of the area 482, while the midpoint handles may be dragged to change a shape of the perimeter of the area 482. Additionally or alternatively, multiple points may be added to the area 482 to further increase the accuracy and/or shape options available to the user. As can be appreciated, the polygonal area button 468 may be used in conjunction with the define area tool 478 and boundary fields in the consolidated group 480. Among other things, this combination of tools may assist in creating well-defined subject property areas 482 in the map area 438.

FIG. 5 is a representation of a consolidated data section 500 of a valuation application 240 in accordance with embodiments of the present disclosure. As provided herein each of the tabs 408 may include one or more consolidated data sections/groups 440. The consolidated data sections/groups 440 may include one or more of tables, charts, menus, form fields, data arrangements, and the like. The arrangement of comparable properties shown in the consolidated data section 500 is one example of the presentation and/or layout of a consolidated data section/group 440, 480. The consolidated data section 500 may be presented via the valuation application 240 to a communication device 208. Additionally or alternatively, more than one consolidated data section may be presented, or grouped, based at least partially on time. For example, a group of comparable properties may be contained in more than one consolidated data section/group 440. In this case, the different consolidated data sections/groups 440 may be arranged based on a recency associated with the data within each respective consolidated data section/group 440. Continuing this example, the sale price data in field 548 may have been collected at a first time in consolidated data section 500 and at a second time for another data section. As such, the consolidated data section 500 may be arranged differently from the other data section based at least partially on this time difference (e.g., between the first and second time, etc.). It should be appreciated that other characteristics associated with the data in each consolidated data section/group 440 may provide similar arrangement of the groups 440 presented via the valuation application 240.

The consolidated data section 500 shows a number of comparable properties for a subject property 104. Each of the comparable properties may include data record 504a-f in the section 500. The data section 500 may include several portions 508-552 representing different types of data. Each of these types of data may be associated with a data record 504a-f. The data section 500 may include fewer portions or more portions 560. Additionally or alternatively, the data section 500 may include fewer or more data records 556.

The first data portion 508 may include an identification of each data record. The identification may include a number, character, symbol, and/or strings thereof. As shown, the data records 504a-f are organized by numbers 1-6. The second data portion 512 can include a status of each data record 504a-f. For example, the status can include whether the comparable property in each data record 504a-f is listed (e.g., coded as “L” in FIG. 5), sold (e.g., coded as “S” in FIG. 5), under contract, withdrawn from the market, etc.

The flag data portion 516 can include one or more options for the market data contained within the data section 500. The one or more options can include dropdown options that are configured to present one or more possible sections to a user. In some embodiments, an appropriate option may be selected automatically, via the valuation application, in the flag data portion for each data record 504a-f. One example of a dropdown option may include flags that can be used to select data as a chosen comparable property, identify a real-estate owned (“REO”) property, and the like, to name a few. For instance, data record 504c reflects in the flag data portion 516 that the data record 504c has been selected as the first comparable property (e.g., “Comp 1”). In some embodiments, if no flag is set, the data record 504a, b, d may be excluded from a market data analysis and/or use.

The data section 500 may include a score portion 520. The score portion 520 may be used to identify a valuation score associated with each of the data records 504a-f. For instance, the comparable property associated with data record 504e lists a valuation score of 98. The comparable property associated with data record 504f lists a valuation score of 40. As can be appreciated, the score of 98 associated with data record 504e indicates that it is a better selection for a comparable property than data record 504f. In some embodiments, one or more data records 504a-f may be used to determine a valuation score. At least one algorithm may be used to generate a valuation score. These algorithms may have multiple inputs, which can be potentially weighted, depending upon importance of input. Additionally or alternatively, the inputs and their weights may vary depending upon the customer that has ordered the valuation, the valuation agent's preference, a user setting, etc. The input weights may be controlled by the entity managing the valuation server 216. In one embodiment, the input weights may be controlled by the valuation agent (e.g., user-programmable, etc.). Examples of algorithms used in determining a ranking, or a valuation score, associated with real property is described in U.S. patent application Ser. No. 11/034,238 to Kim et al., the entire contents of which are hereby incorporated herein by reference.

Other data portions can include an address portion 524, a proximity portion 528, room identification portions 532, 536, a list price portion 540, a days on market (“DOM”) portion 544, a sale price portion 548, and an age portion 552, to name a few. The address portion 524 may identify the physical address of the listed comparable property. The proximity portion 528 may indicate a distance (e.g., in miles, etc.) of the comparable property to the subject property 104. The room portions 532, 536 may identify a number of bedrooms, bathrooms, and/or other rooms in the comparable properties. The list price portion 540 can include current list price information associated with the comparable properties retrieved from one or more valuation data sources 268. As provided herein, the data contained in any of the portions and/or data sections may be updated by the valuation monitor 252 performing a monitoring of the valuation data (e.g., by monitoring the one or more valuation data sources 268, etc.). The age portion 552 may contain information relating to an age associated with the comparable properties listed in the data records 504a-f. It should be appreciated that any combination of these parameters and/or data may be used as inputs for determining a valuation score (e.g., weighted or unweighted, etc.).

FIGS. 6A and 6B depict various embodiments of a site data tab 416 of a valuation application GUI 600. In some embodiments, the GUI 600 can include one or more consolidated data sections 612, 614, 620. Each of the consolidated data sections 612, 614, 620 may include one or more valuation data fields 618a-j and field identifiers 616a-j. The valuation data fields 618a-j may be manually entered (e.g., via a user at a communication device 208, etc.), retrieved from one or more valuation data sources 268, automatically populated, combinations thereof, and the like.

Referring now to FIG. 6A, a representation of a third GUI 600 of a valuation application 240 is shown in accordance with embodiments of the present disclosure. In some embodiments, the site data tab 416 may include one or more consolidated sections 604, 608. Each of the consolidated sections 604, 608 may include an identifier region 612, 620. The identifier region 612, 620 may be configured to identify a group of valuation data contained in the consolidated sections 612, 620. The site information data section 604 may comprise a logical arrangement of data fields 618a-e and corresponding field identifiers 616a-e representing information about a site, or subject property 104. For instance, the site information data section 604 can include an address field 618a and an address identifier 616a, a dimensions field 618b and a dimensions identifier 616b, and more. The field identifiers 616 may serve to identify what information should be, or is, contained in each of the data fields 618.

Examples of data fields 618 may include, but are not limited to, text boxes, dropdown menus, radio buttons, selection boxes, linked fields, other valuation input fields, and combinations thereof. By way of example, the view data field 618f associated with the view factor identifier 616f may include a dropdown menu of available options for selection. As another example, the question-answer fields 618d-e may include radio buttons for selection. Continuing this example, the question provided in the question identifier 616d-e portion of the site information data section 604 may require a “yes” or “no” answer in the answer fields 618d-e. In one embodiment, a user may select the appropriate answer via the radio button (e.g., clicking the appropriate answer to the question identified in the question identifier 616d-e portion, etc).

FIG. 6B is a representation of a fourth GUI 600′ of a valuation application 240 in accordance with embodiments of the present disclosure. In particular, FIG. 6B shows a question identifier 616e, where the answer “yes” has been selected in the question-answer field 618e. In some embodiments, certain fields 616 may require further explanation when information is provided, input, filled, and/or otherwise selected. For example, the question identifier 616e posed the question “Are there any adverse site conditions or external factors.” This question, if answered in the negative (e.g., “no”) may not require further information. However, this question if answered “yes” may require further information regarding the “adverse site conditions.” It is an aspect of the present disclosure to present information to a user via the valuation application 240 in a concise and logical manner. In the example above, when the user selects “yes” as the answer to a question identifier 616 requiring more information (e.g., question identifier 616e), the valuation application 240 may present a new information data section 606 for receiving further information. As shown in FIG. 6B, the adverse external factors data section 606 is presented to allow a user to fill in one or more fields 618m-n, etc. associated with the additional information. The adverse external factors data section 606 may include similar fields and identifiers as previously described. Additionally or alternatively, the data section 606 may include an identifier region 614. The identifier region 614 may be configured to identify a group of valuation data contained in the data section 606.

Other examples of dynamically added fields can be found in reference to FIG. 6A. Specifically, when the dropdown option of “Other” is selected, for example, in fields 618i-j, the section 608 may add fields 622i-j for further explanation. In some cases these fields 622i-j may be user-customizable to include any phrases, words, symbols, and/or other input for selection by a user.

In some embodiments, one or more new data sections 606 may be inserted into the site data tab 416 inside existing data sections 604, 608 or adjacent to the existing data sections 604, 608. As can be appreciated, the one or more new data sections 606 may be configured as one or more fields 618 and field identifiers 616. As one example, the adverse external factors data section 606, shown in FIG. 6B, can be added as a new data section 606 between the site data information section 604 and the site data utilities section 608. In this example, the site data utilities section 608 may be moved in a direction 624 away from the site data information section 604 to make room for the newly added data section 606. Additionally or alternatively, the newly added data section 606 may be arranged in a logical manner close to the field that may have caused it to appear.

FIG. 7 is a representation of a standard valuation form 700 having one or more form field identifiers 716 mapped to fields 618 provided by the valuation application 240 in accordance with embodiments of the present disclosure. Although shown as a Form 1004 URAR form (e.g., listed in the form identifier area 704), it should be appreciated that any standard, or paper, form may be mapped to digital valuation form data provided and stored via the valuation application 240 described herein. Some forms may contain information, which may be common among valuation forms, such as subject property 104 address 716a, dimensions 716b, area 716c, and utilities 716g-j. In some embodiments, this information may be mapped to data sections 440, 500, data records 504, fields 618, and field identifiers 616 associated with the valuation application 240 and as described in conjunction with FIGS. 4-6. For example, the form dimensions identifier 716b may be mapped to the valuation application 240 dimensions identifier 716b. As can be appreciated, data associated with the valuation application 240 (e.g., the dimensions provided in the dimension field 616b, comparable information from data records 504, etc.) may be automatically filled in the appropriate location of the standard form via the valuation application 240. Mapping data may be stored in one or more components of the system 200, such as the rules engine 236, the form module 244, and in a memory.

In some embodiments, a standard form (e.g., Form 1004, company forms, etc.) may be scanned by, or entered into, a system 200, and the various field identifiers 716 can be analyzed via the valuation application 240. These field identifiers 716 may be automatically determined to correspond to one or more of the sections 440, 500 and/or field identifiers 616 stored in memory. Once the standard form has been analyzed and all of the appropriate field identifiers 716 have been identified and/or mapped to corresponding valuation application 240 data, the mapping and/or layout may be stored as a template in memory. This template may be used by the valuation application 240 and/or components of the valuation server 216 in translating, converting, and/or writing data compiled as part of the valuation work flow 300.

In one embodiment, the valuation application 240 may prepare a standard form (e.g., by filling all appropriate fields 716 of the standard form, etc.) from data compiled via the valuation application 240. In some embodiments, the valuation application 240 may read a standard form (e.g., via a scanner or other device capable of reading a standard form) and populate valuation data in the valuation application 240 from the standard form.

FIG. 8 is a flow diagram depicting a method 800 of pushing a valuation work order to valuation agents in accordance with embodiments of the present disclosure. The method 800 begins at step 804 and proceeds when a valuation work order is generated (step 808). In some embodiments, valuation work orders may be generated by one or more users and/or in response to receiving an input from a user's communication device 208.

For instance, a valuation work order may be generated via a broker who is seeking valuation information associated with one or more subject properties. In this case, the broker may enter at least one subject property address into a work organizer 228 of a valuation server 216. Additionally or alternatively, the broker in this example may enter a specific type of valuation (e.g., simple, comprehensive, BPO, form type, etc.) via the valuation service. In any event, once the information is entered, the method 800 may proceed by creating a valuation work flow in accordance with the valuation work order. In some cases, the valuation work flow may be similar to that described in conjunction with FIG. 3.

The method 800 may continue by pushing a notification of the generated work order to one or more qualified valuation agents (step 812). The pushed notification may be in the form of an email, text message, alert, post, phone call, social media notification, or some other signal sent from the valuation server 216 to at least one communication device 208 of a valuation agent. In some embodiments, a valuation agent may be selected (e.g., considered qualified, etc.) based on a rating and/or performance score. For instance work orders may be sent to valuation agents who have provided accurate valuations in the past (e.g., based on historical data, etc.). In one embodiment, the accuracy of valuations may be judged and/or graded by one or more users of the system 200 (e.g., work order generating users, peers, combinations thereof, and the like).

In some embodiments, a valuation agent may be considered as qualified to receive the push notification of the work order based on a geographical location associated with the valuation agent. As provided herein, the valuation server 216 may request location information associated with a valuation agent. In one embodiment, the location information may be provided by the valuation agent's communication device 208 via one or more of satellite position (e.g., Global Positioning System (“GPS”)), Wi-Fi hotspots, cell tower data, IP address, indoor positioning system (e.g., iBeacon®, Bluetooth® low energy proximity sensing, and the like), etc. For example a valuation agent who is closer to the subject property associated with a work order may be selected before a valuation agent who is located further from that subject property. As can be appreciated, the location and/or rating of a valuation agent may be used alone, or in combination, to determine a qualified valuation agent to receive the push notification of the work order.

Next, the method 800 determines whether an acceptance of the work order is received from one or more valuation agents (step 816). In one embodiment, a valuation agent may accept a work order directly from the pushed notification. For example, the pushed notification may include a selection mechanism (e.g., in the form of a button, link, and/or the like) by which a valuation agent may accept, deny, and/or ignore the work order. In another embodiment, the valuation agent may access the valuation server 216 to accept the work order. In any event, when a valuation agent accepts the work order, a signal may be sent to the valuation server 216 and/or the work organizer 228 indicating the acceptance by the valuation agent.

In the event that no acceptance is received within a given time period, the method 800 may continue by expanding the qualified valuation agent pool (step 820). The time period may be predetermined, set by a work order generator (e.g., a user, etc.), and/or determined based on a time associated with the work order. Expanding the qualified valuation agent pool may include relaxing at least one of the valuation agent qualification settings previously determined in the notification step 812. For instance, a qualification rating or score associated with a valuation agent may be lowered to increase the number of available qualified valuation agents. In another example, a location associated with qualified valuation agents may be increased. In this case, the distance of the valuation agent to the subject property of the valuation work order may be increased. Once the qualified valuation agent pool is expanded, the method 800 may return to step 812.

When an acceptance is received at the valuation server 216, the method 800 continues by determining whether more than one acceptance was received (step 824). If more than one acceptance is received, the method 800 may filter the valuation agents based on one or more qualifications (step 828). For instance, the closest valuation agent to the subject property may be selected. In one example, the valuation agent with the highest rating and/or score may be selected. In yet another example, the valuation agents may be filtered according to an acceptance/response time (e.g., on a first-come, first-served basis, etc.). In any event, the work organizer 228 may filter the valuation agents before the work order is assigned.

Once a qualified valuation agent has accepted the work order and/or has been selected via the work organizer 228, the work organizer 228 may then assign the valuation agent to the valuation work order (step 832). In some embodiments, the assignment may include providing the valuation agent with authorization/access to the work order. This authorization/access control may restrict other, unassigned, valuation agents from accessing the work order. In one embodiment, the assigned valuation agent may be provided with permissions (e.g., password, device id, key, etc.) to access the work order. Additionally or alternatively, an identification of the assigned valuation agent may be associated with the work order. One example of identification may include listing a valuation agent's name and/or identification number with a work order. The method ends at step 836.

FIG. 9 is a flow diagram depicting a method 900 of populating a digital valuation form with retrieved valuation data in accordance with embodiments of the present disclosure. The method begins at step 904 and proceeds by generating a valuation work order (step 908). In some embodiments, valuation work orders may be generated by one or more users and/or in response to receiving an input from a user's communication device 208. The valuation work order may include at least one of a subject property address, work flow scheme, requested valuation agent, valuation type, valuation standards, and the like.

The method 900 continues by retrieving data from one or more valuation data sources 268, as provided herein. In one embodiment, the valuation server 216 may retrieve valuation information based on the work order generated in step 908. For instance, the work order may include a subject property address and a valuation type having specific valuation standards. Continuing this example, the valuation server 216, in conjunction with the valuation application 240, may determine that the valuation type and/or valuation standards require comparable properties within a specific range (e.g., zone 150-158) of the subject property 104. In this case, the valuation server 240 may retrieve valuation information relating to the comparable properties. The valuation information can be in any of the formats, presentations, and layouts, as disclosed herein. In one embodiment, the valuation information may be contained in a format similar to the data section 500 and data records 504 described in conjunction with FIG. 5.

The method 900 may populate sections of the digital valuation form provided via the valuation application 240 with the valuation information retrieved in step 912 (step 916). Continuing the example provided above, the comparable property information may be included in the market data tab 412 of the valuation application 240. In accordance with embodiments of the present disclosure, the digital valuation form may be pre-populated with the valuation information before the work order is assigned to a valuation agent. In some embodiments, the pre-population (i.e., populating information prior to assignment, etc.) of information may be performed automatically (e.g., in response to a work order being generated, etc.).

The method 900 may continue by identifying and/or mapping the populated data with field identifiers 616, 716 retrieved (step 920). In one embodiment, the field identifiers may be retrieved from memory based at least partially on the valuation type defined as part of the work order. In this step, various fields 618 may be automatically populated in the digital valuation form along with an associated standard form location indicated by the standard form field identifiers 716. Among other things, this map of digital valuation form fields 618 to standard form field identifiers 716 and standard form fields may be stored in memory.

Next, the digital valuation form may be compiled for continued preparation by a valuation agent (step 924). In some embodiments, compiling the digital valuation form may include determining a presentation for the digital valuation form. The presentation may include a location of features and/or an inclusion of features, such as consolidated data sections 440, 480, 500, various fields 618 and field identifiers 616, further information sections, dropdown menu options, and the like. Additionally or alternatively, compiling the digital valuation form may include altering at least one portion the GUI of the valuation application 240. In some cases, various elements of the digital valuation form may be altered. One element that may be altered is the tab identifier 428 described in conjunction with FIGS. 4A and 4B. For instance, a color of the tab identifier 428 may be changed to indicate that valuation data was retrieved from the one or more valuation sources 268.

The method 900 continues by presenting the digital valuation form to a valuation agent (step 928). Presentation of the digital valuation form may include providing the digital valuation form to a communication device 208 via the valuation application 240 on the valuation server 216. In some embodiments of the present disclosure, the digital valuation form may be accessed by the valuation agent via a communication device 208 and thin client in communication with the valuation server 216. The method 900 ends at step 932.

FIG. 10 is a flow diagram depicting a method of creating a digital valuation form in accordance with embodiments of the present disclosure. The digital valuation form may be created automatically. Additionally or alternatively, a digital valuation form may be created via user input from a web-enabled communication device 208. The method 1000 starts at step 1004 and proceeds by determining one or more fields 618, field identifiers 616, and a presentation layout for the digital valuation form (step 1008). This determination may include whether a particular field 618 is provided with a dropdown menu, options, textbox, date selection box, radio button, formatting therefor and the like. In some cases, the field 618 and/or the field identifier 616 of the digital valuation form may include a tooltip, help function, and/or some other inline assistance feature. It is anticipated that during the determination, the valuation application 240 may incorporate one or more of these features into the digital valuation form. Additionally or alternatively, various data sections, follow-on information fields, and/or other context sensitive features may be determined in this step (1008).

In some embodiments, a standard form may be scanned (e.g., via an optical scanner, etc.) and/or otherwise presented to the valuation server 216 in a readable format. By way of example, the standard form may include optical features (e.g., letters, boxes, shapes, symbols, etc.) that can be recognized by recognition software of the system 200. Once the optical features are recognized, components of the valuation server 216 may determine corresponding digital valuation form elements, such as fields 618 and/or field identifiers 616 that can included in the digital valuation form. The process of reading the standard form, determining corresponding digital valuation form elements, and determining the layout of the digital valuation form may be performed automatically by the various elements of the system 200.

The method 1000 may continue by combining the determined fields 618 and/or field identifiers 616 into logical groups (step 1012). One example of a logical group may be represented by a consolidated data section 440, 480, 500. Another example of a logical group may include a presentation of the fields 618 and/or field identifiers 616 in a layout within one or more of the application areas defined by the data tabs 408 of the valuation application 240. In some embodiments, the fields 618 and/or field identifiers 616 may be combined by a property (e.g., subject property 104, comparable property, combinations thereof, etc.). For example, questions and data relating to a subject property 104, although found in separate areas/locations on a standard form, may be combined into one area/location on the digital valuation form. This combination can allow a user to enter all data pertaining to the subject property 104 in one location on the digital valuation form. In one embodiment, the fields 618 and/or field identifiers 616 can be combined into logical groups based on a source (e.g., one or more valuation data sources 268) associated with the information. In any event, the data may be combined in a logical manner to increase efficiency in filling the form, completing data entry, and the like.

Once the fields 618 and/or field identifiers 616 are combined into logical groups, the method 1000 may continue by arranging the logical groups in the digital valuation form (step 1016. Among other things, this arrangement may include a placement on an area of the digital valuation form. The placement can include a defined size and a location of the logically grouped fields 618 and/or field identifiers 616.

Next, the method 1000 may optionally map the arrangement of the logical groups, including the fields 618 and/or field identifiers 616, to locations associated with a standard form (step 1020). Although various fields 618 and/or field identifiers 616 may have been compiled into logical groups for presentation by the digital valuation form, these fields 618 and/or field identifiers 616 may be out of order on a standard form. In some embodiments, the valuation application 240 may correlate the location of each field 618 and/or field identifier 616 in the digital valuation form with corresponding field identifier 716 and field locations on the standard form. For example, a utilities field 616g may be in the first location on a digital valuation form, but may be found on “Page 2, Line 23” (e.g., P2L23SF) of a standard form. In this example, the utilities field 616g may be mapped to the location P2L23SF of the standard form. This mapped location may be stored in a memory of the system 200. In some embodiments, a particular field 616 of a digital valuation form may be found in several locations on a standard form. It is an aspect of the present disclosure that this field may be mapped to several locations on the standard form.

The method 1000 may continue by providing elements, such as the various fields 618 and/or field identifiers 616 as well as the presentation and/or other determinations made step 1008 in the digital valuation form (step 1024). In some cases, providing the elements to the digital valuation form may include retrieving an element (e.g., a dropdown menu, option, selection box, text box, etc.) from memory and inserting the element into a determined location of the digital valuation form.

Once the digital valuation form has been created, with any logical groups, layouts, elements, etc. the method 1000 may continue by saving the digital valuation form in memory (step 1028). In some cases, the digital valuation form may be stored in memory as a template. The template may be retrieved by a user as part of a valuation work order. As can be appreciated, the template may be associated with one or more of, a valuation type, standard form type, business, user, entity, and combinations thereof. The method 1000 ends at step 1032.

FIG. 11 is a flow diagram depicting a method 1100 of monitoring valuation data associated with a digital valuation form in accordance with embodiments of the present disclosure. The method 1100 begins at step 1104 and proceeds when valuation data is input into the digital valuation form via the valuation application 240 (step 1108). Valuation data may include any of the data as described herein. Additionally or alternatively, the valuation data may be entered by a user and/or retrieved from one or more valuation sources 268. In any event, the method 1100 continues by monitoring the valuation data input into the digital valuation form (step 1112).

Next, the method 1100 may determine whether the data input into the digital valuation form conforms to valuation rules stored in memory (step 116). Valuation rules may include dynamic error checking, conformity with other fields 618, correlation with field identifiers 616, and the like. If the data input does not conform to the valuation rules, the method 1100 may provide a valuation rule data input warning (step 1120). The warning may be part of a message to a user. In some cases, the warning may include a formatting and/or identifier associated with the nonconforming data. For example, a field 618, field identifier 616, data section 440, 480, 500, and other valuation data may be highlighted and/or associated with a warning indicator. The method 1100 can return to step 1112, and may even prevent the user from saving the digital valuation form until the data input conforms to the valuation rules.

If the data input into the digital valuation form conforms to the valuation rules, the method 1100 may determine whether the data input associated with the digital valuation form is complete (1124). In some embodiments, a completion of data input may be related to one or more of a tab 408, section 440, 480, field 618, and an entirety of the digital valuation form. If the data input is incomplete, the method 1100 may return to continuing to monitor data input into the digital valuation form (step 1112). In the event that the data input is determined to be complete, the method 1100 may end at step 1128.

Referring to FIG. 12, a flow diagram depicting a method 1200 of converting digital valuation form data into a standard valuation form is shown in accordance with embodiments of the present disclosure. The method 1200 begins at step 1204 and continues when the valuation server 216 receives a completed digital valuation form (step 1208). In some embodiments, the valuation server may receive the completed digital valuation form when a user selects that the digital valuation form is complete. For instance, a user may select to save the form for further processing. In another example, a user may select to convert the form from digital format to at least one standard form format. In yet another example, the valuation application 240 may determine that the digital valuation form is complete (e.g., by detecting that all fields 618 have been completed, etc.).

The method 1200 may continue by performing a conversion error check on the data contained within the digital valuation form (step 1212). Among other things, the error check may determine that each required field of a standard form is mapped to a field 618 from the digital valuation form. When a conversion error check determines that an issue may exist for converting the digital valuation form to a standard valuation form, the valuation application 240 may notify a user of the issue (step 1216). The notification may be in the form of a warning or other message.

Next, the method 1200 continues by automatically creating the standard valuation form using the data contained within the digital valuation form (step 1220). This data may be written to the standard form based on the map information (e.g., stored in memory, etc.) correlating field data of the standard form with fields 618 of the digital valuation form. Once all of the appropriate fields of the standard form are populated with the digital form data, the method 1200 may proceed by saving the standard form in memory as a converted standard form (step 1224). The converted standard form may subsequently be sent to an entity for use in valuation. For example, the converted standard form may be sent to a broker via email. Additionally or alternatively, a user may be alerted (e.g., via the valuation server 216) that a converted standard form has been saved. The method 1200 ends at step 1228.

FIG. 13 is a flow diagram depicting a method of converting input received at a digital valuation form into multiple types of standard valuation forms in accordance with embodiments of the present disclosure. The method 1300 begins at step 1304 and continues when the valuation server 216 receives input at a digital valuation form (step 1308). In some embodiments, the valuation server 216 may receive a completed digital valuation form. In one embodiment, the valuation server 216 may detect that input has been written to a specific filed 618 of the digital valuation form. In any event, the method 1300 may determine to output data from the digital valuation form to multiple different valuation formats (step 1312). In one embodiment, the valuation server 216 may determine that a user has provided an input to generate multiple different valuation formats. For example, the multiple different valuation formats may represent at least two or more of a URAR, a BPO, a light appraisal summary for a homeowner and/or home buyer, a bank-specific BPO, and a broker-specific BPO, to name a few.

It should be appreciated that the data collected via the valuation application 240 and the digital valuation form can be output in any report format. For instance, a user may select to save the digital valuation form data in multiple different valuation report formats. In some cases, the valuation application 240 may determine that the digital valuation form includes enough data for various valuation formats. This determination may be presented to a user via the valuation application 240. For example, as a user completes a digital valuation form, the valuation application 240 may indicate that the data can generate a first report type. Continuing this example, as the user continues to complete the digital valuation form (e.g., by adding more data fields 618, etc.) the valuation application 240 may indicate that the data in the digital valuation form can generate a first report type, a second report type, and even more.

Optionally, the method 1300 may perform an error check similar to that described in conjunction with FIG. 12. In some cases, the error check may determine that each required field of the multiple different valuation formats is mapped to a field 618 from the digital valuation form. When a conversion error check determines that an issue may exist for converting the digital valuation form to one or more of the multiple different valuation formats standard, the valuation application 240 may notify a user of the issue. As can be appreciated, the notification may be in the form of a warning or other message presented to a user.

The method 1300 may continue by automatically generating the multiple different valuation formats using the data contained within the digital valuation form (step 1316). This data may be written to the multiple different valuation formats based on the map information (e.g., stored in memory, etc.) correlating field data of the multiple different valuation formats with fields 618 of the digital valuation form.

Once all of the appropriate fields the multiple different valuation formats are populated with the digital valuation form data, the method 1300 may proceed by saving the multiple different valuation formats in memory as completed forms (step 1320). These completed forms may be sent to an entity for use in valuation. For instance, the completed forms may be sent to a broker, a banker, a user, and/or more than one receiving entity via email or other communication type. Additionally or alternatively, a user may be alerted (e.g., via the valuation server 216) when at least one of the completed forms has been saved. The method 1300 ends at step 1224.

With reference now to FIG. 14, additional details related to the preparation of data for presentation to a valuation agent will be described in accordance with embodiments of the present disclosure. In particular, a presentation framework 1420 is shown as the delivery vehicle of one or more pages (e.g., HTML pages, web pages, etc.) to a communication device 208 operated by a valuation agent in connection with developing a valuation opinion or appraisal for a subject property. The presentation framework 1420 includes a layout module 1424 and an XML template (or similar type of template) that is configured to receive data integrity rules 1432 and/or business logic 1436 and use such inputs to appropriately format a data entry page for a valuation agent.

As discussed above, a form 1404 may have a certain number of selected fields 1408 from a candidate population of available fields 1416. A process for delivering a customized data entry page to a valuation agent for a custom-built form 1404 may begin with a human and/or computer analyzing a form that a client desires to have filled in connection with a valuation of a subject property. In a simple case, the desired form may correspond to a URAR where the data fields required to complete the form 1404 are well known and standardized and the locations where values entered into such data fields is also well known and standardized. In other embodiments, a customer may deliver a custom form for some other valuation (e.g., a BPO form that is specific to that particular customer). When the form is received, the human and/or computer analyzing the form to determine which data fields from the entire population of available fields 1416 are to be included in the custom form.

The data fields identified in this step are then imported into the custom form 1404 (step S1401). As a non-limiting example, a human may identify that the following data fields are to be included in the form: CURRENT DATE, SUBJECT ADDRESS, SUBJECT SQUARE FOOTAGE, SUBJECT NUMBER OF ROOMS, SUBJECT NUMBER OF BATHROOMS, SUBJECT LOT SIZE, SUBJECT BUILT DATE, COMP #1 ADDRESS, COMP #1 SQUARE FOOTAGE, COMP #1 NUMBER OF ROOMS, COMP #1 NUMBER OF BATHROOMS, COMP #1 LOT SIZE, COMP #1 BUILT DATE, . . . , etc. Each of the selected fields 1408 may have field metadata 1412 associated therewith. The field metadata 1412 may define the input requirements for the associated field 1408, the range limits for the associated field 1408, format requirements for the associated field 1408, and any other rule related to the value that can be input into that associated field 1408. In some embodiments, a field may correspond to a composite field and the associated field metadata 1412 may further define what values are to be input into that field and the format for outputting the multiple values into the form 1404.

After the selected fields 1408 have been identified and their associated metadata 1412 has been loaded into the form 1404, the process continues by delivering the newly-built form 1404 to the presentation framework 1420 (step S1402). In a simple implementation, the presentation framework 1420 may serially lay out each selected field 1408, or more precisely a data entry element (e.g., text entry box, dialog box, drop down menu, radio buttons, etc.) configured to receive a value or input that will ultimately be assigned to the associated field as a field value. The simple layout of the data entry elements for the selected fields 1408 may then be provided to the communication device 208 via a web page or web portal (step S1404).

In a more intelligent implementation, the presentation framework 1420 may receive the data integrity rules 1432 and/or business logic 1436 (step S1403) and use such inputs to determine an optimal layout for the selected fields 1408. More specifically, the presentation framework 1420 may utilize the layout module 1424 to select the optimal layout for the selected fields 1408 based on the data inputs received in step S1403 and then the layout module 1424 may instruct the XML template 1428 to develop and deliver the appropriate web layout. The XML template 1428 may take each of the selected fields 1408 and place them into an appropriate order within the dynamically-designed web page. As a non-limiting example, the business logic 1436 may define that all data fields related to the subject property should be presented before any data fields related to a comparable property. As another example, the data integrity rules 1432 may define that certain fields should only have a radio box initially presented and if that radio box becomes checked, then a further dialog box may be displayed to receive additional data for the associated data field.

Advantageously, the order of presentation of the selected fields 1408 does not have to correspond to the order in which the selected fields are ultimately presented in a form when delivered to the customer. Specifically, a customer's form may have the date in the upper left hand corner of the first page followed by basic information about the subject property and then basic information about the comparable properties and then detailed information or notes about the subject property. The presentation framework 1420, on the other hand, can allow the valuation agent to input all information related to the subject property before inputting information about a comparable property, thereby making the data entry easier and more logical. Because the data entry page presented to the valuation agent is form-agnostic, the valuation agent can logically input the appropriate data without having to concern themselves with the specific format of the custom form that will ultimately delivery the information input by the valuation agent.

Moreover, the same order of presentation for data fields may be followed by the presentation framework 1420 regardless of the type of form an agent is filling out. In other words, an agent can be provided with the same order of questions or data field entry elements for different forms, even if those different forms will deliver the input data in a different order from one another. Clearly, this makes the data input process much easier for the valuation agent.

In some embodiments, the human and/or computer that identified the selected fields 1408 may also identify a mapping of the selected fields to a particular x-y location within the form 1404. This mapping can be used to deliver each input value for a data entry element to the correct location on a page, thereby allowing a form to be filled out in compliance with a customer's requirements. Thus, once all of the fields have been properly filled in by the agent, the values for those fields may be mapped to the appropriate location on the form 1404 and the form 1404 can be delivered to the customer (possibly after further quality control checks are performed).

With reference now to FIG. 15, additional details related to an inheritance model used for the development and management of forms 1504, 1516, 1520 will be described in accordance with embodiments of the present disclosure. The inheritance model shows how a form 1504 at a root node can be used as the basis for developing additional children/leaf node forms 1516, 1520. Specifically, the form 1504 at the root node may have a field step 1508 and rule set 1512 associated therewith. The field set 1508 may include 125 fields that have been selected (e.g., by a human and/or computer) for the form 1504. The rule set 1512 may define the rules associated with entering data into the selected fields in the field step 1508 as well as rules associated with entering data into the form 1504. Alternatively or additionally, the rule set 1512 may contain government and/or client-specific rules for completing the form 1504.

In some embodiments, if a valuation agent has not worked on the form 1504 since one or more rules in the rule set 1512 have been updated, the system (e.g., rules engine 236) may provide a notification of the updated rules to the valuation agent along with a requirement that the agent acknowledge an understanding of the updated rules prior to working on the form 1504. If the updated rule was also inherited into a rule set 1512 of any leaf node (e.g., forms 1516a, 1516b, 1516c, 1520, etc.), then the valuation agent may also be prohibited from working on such forms until the agent acknowledges an understanding of the updated rule. Advantageously, since the valuation agent will likely be accessing the valuation server 216 remotely (e.g., via web page or browser), it is possible to track the agent's activity history and if any rule update occurs in between access times for an agent, that agent can be automatically notified of the updated rule prior to allowing the agent further access to any forms, whether such forms are completely or partially completed.

As shown in FIG. 15, forms at a child node may be quickly built based upon field sets 1508 and/or rule sets 1512 of a direct or indirect parent. This enables the quick deployment of new forms that have at least some similarity to forms that already exist in the system. Consider the following example, form 1504 may be preexisting and may have FIELD 1, FIELD 2, FIELD 3, FIELD 4, . . . , FIELD X in its field set 1508 as well as RULE 1, RULE 2, RULE 3, . . . , RULE Y in its rule set 1512. If a new form is to be built that is similar to form 1504, instead of creating a new form, the inheritance model can be used to quickly create a new form with the existing form 1504 as a template. The building of the new form (e.g., form 1516c) may commence by establishing the relationship between the existing form 1504 and the new form 1516c in the inheritance model. At this point, the new form 1516c will have the exact same field set 1508 and rule set 1512 values as its parent. However, the new form 1516c can be customized relative to its parent form by selecting which fields and/or rules should be added (e.g., ADD FIELD W), removed (e.g., REMOVE RULE 2), relocated (e.g., MAP FIELD 1 to new location in form), and/or modified (e.g., CHANGE RULE 1 from >= to only >) relative to the existing form 1504. Once the customizations have been defined, the new form 1516c can exist in the inheritance model as an independent form that is selectable for use within the system.

In some embodiments, if a rule is update in the rule set 1512 of the form 1504, then the inheritance model can quickly update all other instances of the same rule within the other rule sets 1512 due to the reference established between the forms. Thus, there is no need to individually update a rule in each form. Instead, the rule can be updated one time in the form 1504 and the child nodes, grandchild nodes, etc. can have their instance of the same rule (if such a rule exists in the forms) updated automatically.

With reference now to FIG. 16, a detailed explanation of a quality control method 1600 will be described in accordance with embodiments of the present disclosure. The method 1600 begins when a valuation agent starts entering data into a web page that has been built for a particular valuation form (step 1604). The quality control method 1600 described herein can be applied to the completion of a form generated in accordance with embodiments of the present disclosure or to the completion of a static form.

The method continues with the continuous and iterative checking of the valuation agent's inputs in the fields that are presented to the agent from the valuation server 216 (step 1608). The valuation agent's inputs may be checked based on the field metadata 1412 for each field being completed by the agent as well as other data integrity rules 1432. If the system detects any non-compliance with the quality control rules at the agent input phase (step 1612), the agent will be alerted of the improper input (step 1616) and will be further required to input the appropriate data before being allowed to continue and submit the input values for delivery in a completed form.

After the agent has input values into each of the selected fields 1408 for the form (step 1620) and all of the input values have passed the continuous and iterative analysis applied at steps 1608, 1612, 1616, the method 1600 continues by providing the input values to another QC module (step 1624). The next QC module will then perform another and different analysis of the input data. In this particular analysis, the input values may be compared to one another and then to certain business rules that define appropriate inputs. For instance, rules related to distance between a comparable property and subject property may be analyzed in the loop 1608, 1612, 1616 whereas rules related to bracketing (e.g., ensuring that the value of the subject property is bracketed by the values of two different comparable properties) may be analyzed at step 1624. Other complex rules or rules requiring the simultaneous comparison of multiple different input values may be analyzed and checked in step 1624.

The method 1600 continues with the QC module determining if the input values passed the second phase of quality control (step 1628). If the query is answered affirmatively, then the input data values are packaged into one or more selected formats (e.g., via the mapping process described above) and delivered via one or more forms to the client(s) (step 1636). Thereafter, the method 1600 will end.

On the other hand, if the query of step 1628 is answered negatively, then the appropriate QC personnel may be notified of the failed analysis and the QC personnel may be asked to communicate and/or iterate with the valuation agent about further support for the input values and/or the agent may be asked to obtain and input new data values (step 1632). Although not depicted, then method 1600 may then return back to step 1608 where the valuation agent begins inputting new data values.

With reference now to FIG. 17, a method 1700 of managing data input by a valuation agent will be described in accordance with embodiments of the present disclosure. The method 1700 begins with a start operation 1704 and ends with an end operation 1740. After starting 1704, the method 1700 proceeds with receiving agent inputs after such inputs have passed the appropriate QC processes (see e.g., FIG. 16) (step 1708).

The method 1700 continues by determining whether the received inputs will be stored for later use and/or reference (step 1712). If the answer to step 1712 is affirmative, then the agent inputs are stored in a database as an agent work file (step 1716). References and/or pointers to the stored data may also be maintained to enable future reference to the data. In some embodiments, the entirety of the agent's inputs are stored as part of the work file, regardless of whether or not the entirety of the agent's inputs will be output in a form. The storage of the entire agent work file can serve multiple purposes. First of all, if there is a need to validate the agent's work at a point in the future, the agent's work file can provide the primary mechanism for validating the work. Secondly, if the same subject property needs a new valuation in the future, then the agent's work file can provide a starting point for the new valuation. In other words, the valuation performed on the same subject property does not necessarily need all of the information re-entered by the agent performing the new valuation, regardless of whether or not the agent performing the new valuation performed the previous valuation. Information like subject property address, year built, lot size, etc. can be borrowed from the work file of the previous valuation.

Thereafter, or if the query of step 1712 was answered negatively, the method 1700 proceeds by determining if one or more forms will be output based on the data input by the agent (step 1720). If the answer to step 1720 is negative, then the method 1700 ends (step 1740).

On the other hand, if the answer to step 1720 is affirmative, then the method 1700 proceeds by determining the desired form output and mapping the input values to the appropriate locations on the form (step 1724). In some embodiments, the mapping step may have been performed when the form was created and the fields were selected. As an example, when a field is selected, it may also be mapped to a particular location on a page of paper (e.g., FIELD 15 corresponding to COMP #1 ADDRESS may be mapped to page 5, 5 inches down and 2 inches to the right of the top right corner of the page).

Based on the mapping of input values performed in step 1724, the input values are packaged into the appropriate format for delivery of the form (step 1728). Furthermore, the desired type of output for the form (e.g., pdf copy, paper copy, embedded email, HTML page, etc.) may be generated with the appropriate input values in the determined locations.

The method 1700 proceeds by determining if more forms are to be output with some or all of the data input by the valuation agent (step 1732). If the answer to step 1732 is affirmative, then the method 1700 returns to step 1724. If the answer to step 1732 is negative, then the method proceeds by delivering the form(s) in the appropriate delivery format (step 1736). Thereafter, the method 1700 ends (step 1740).

With reference now to FIG. 18, a method 1800 of customizing workflows and associating workflows with customers and/or products will be described in accordance with embodiments of the present disclosure. The method 1800 begins at step 1804 and proceeds when information regarding one or more custom workflows is received at a workflow engine (step 1808). Although not depicted, the workflow engine may be part of the valuation server 216 or a component thereof. A workflow may contain each step performed in connection with preparing and/or delivering a product (e.g., a form along with other data) to a customer or client. Different workflows may be defined for different clients and/or products. For instance, one product may require a particular QC process whereas another product may require a lesser amount of QC. As another example, one client may require multiple appraisals on a subject property whereas another client may only require a single appraisal on a subject property. These requirements, whether client-specific or product-specific may be associated with a custom workflow (step 1812). Thus, when delivering a product or a form to a particular client having w custom workflow associated therewith, the workflow will be enforced in connection with the delivery of the associated product or with the delivery of the form to the associated customer (step 1816).

A further aspect of the present disclosure may include monitoring valuation data entered into the digital valuation form. It should be appreciated that monitoring of valuation data may include periodically verifying a state of the valuation data. For instance, comparable property data may be input into the digital valuation form and tied to a particular field 618. As can be appreciated, the comparable property data may be subject to change. In this example, data relating to the listing status of the comparable property may change from time to time. In any event, the valuation monitor 252 may request new data related to the listing status. The request can be made of the one or more valuation sources 268 and/or a user. It is an aspect of the present disclosure that the valuation monitor 252 may subscribe to one or more of the valuation sources 268 and services to receive valuation data updates without making the requests. For example, embodiments of the present disclosure anticipate receiving valuation data updates when the valuation data changes at the source.

Although the present disclosure provides that a digital valuation form may be arranged based on a selected valuation type, embodiments of the present disclosure should not be so limited. In some embodiments, the digital valuation form may be presented as a universal digital valuation form. In this example, the universal digital valuation form can include one or more fields 618 and field identifiers 616 arranged in a predetermined order. This predetermined order may be regardless of defined valuation type and/or work order parameters.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

What is claimed is:

1. A method, comprising:
determining that a new form is to be generated for delivery of valuation information to a customer;
selecting a set of fields contained within the new form, wherein each field in the set of fields is selected from a population of available fields and wherein the set of fields comprises a subset of fields from the population of available fields;
identifying metadata associated with each field in the set of fields;
based on the set of fields and the metadata associated therewith, generating a web page that contains data entry elements for each field in the set of fields; and
delivering the web page to a communication device of a valuation agent.

2. The method of claim 1, further comprising:
receiving, at a server, the valuation agent's data inputs for at least one field in the set of fields;
providing each data input to a predetermined location of the new form to create a first completed form; and
delivering the first completed form to the customer.

3. The method of claim 1, wherein at least one of the fields from the set of fields contains valuation data for real property and wherein the first user-selected form includes at least one of a broker price opinion (BPO) in a predefined customer-selected format, a comprehensive valuation report, a universal residential appraisal report (URAR), a government valuation form, and a company-specific valuation form.

4. The method of claim 1, wherein the new form corresponds to a standardized form.

5. The method of claim 4, wherein the standardized form is at least one of a government-standard form and an enterprise-standard form.

6. The method of claim 1, wherein the web page delivered to the communication device is dynamically generated with an eXtensible Markup Language (XML) template based on at least one of data integrity rules and business logic.

7. The method of claim 1, wherein a layout module organizes the data entry elements in an order that is different from an order in which corresponding fields are presented in the new form.

8. The method of claim 7, wherein the layout module is further capable of accepting annotations for one or more fields from the set of fields and appending the annotations to a completed version of the new form.

9. The method of claim 1, further comprising:
determining that a second form is to be generated for delivery of valuation information to a second customer;
creating the second form;
establishing an inheritance relationship between the second form and the new form such that at least some rules and fields of the new form are inherited by the second form;
identifying at least one difference between the second form and the new form; and
based on the inheritance relationship and the identifies at least one difference, generating a web page that contains data entry elements for each field in the second form.

10. The method of claim 9, wherein a change to at least one of a field and rule in the new form is automatically inherited by a corresponding at least one of a field and rule in the second form.

11. A non-transitory computer readable medium having stored thereon instructions that, when executed by a processor, perform a method comprising:
determining that a new form is to be generated for delivery of valuation information to a customer;
selecting a set of fields contained within the new form, wherein each field in the set of fields is selected from a population of available fields and wherein the set of fields comprises a subset of fields from the population of available fields;
identifying metadata associated with each field in the set of fields;
based on the set of fields and the metadata associated therewith, generating a web page that contains data entry elements for each field in the set of fields; and
delivering the web page to a communication device of a valuation agent.

12. The computer readable medium of claim 11, wherein the method further comprises:
receiving, at a server, the valuation agent's data inputs for at least one field in the set of fields;
providing each data input to a predetermined location of the new form to create a first completed form; and
delivering the first completed form to the customer.

13. The computer readable medium of claim 11, wherein at least one of the fields from the set of fields contains valuation data for real property and wherein the first user-selected form includes at least one of a broker price opinion (BPO) in a predefined customer-selected format, a comprehensive valuation report, a universal residential appraisal report (URAR), a government valuation form, and a company-specific valuation form.

14. The computer readable medium of claim 11, wherein the new form corresponds to a standardized form.

15. The computer readable medium of claim 14, wherein the standardized form is at least one of a government-standard form and an enterprise-standard form.

16. The computer readable medium of claim 11, wherein the web page delivered to the communication device is dynamically generated with an eXtensible Markup Language (XML) template based on at least one of data integrity rules and business logic.

17. The computer readable medium of claim 11, wherein a layout module organizes the data entry elements in an order that is different from an order in which corresponding fields are presented in the new form.

18. The computer readable medium of claim 11, wherein the method further comprises:
determining that a second form is to be generated for delivery of valuation information to a second customer;
creating the second form;
establishing an inheritance relationship between the second form and the new form such that at least some rules and fields of the new form are inherited by the second form;
identifying at least one difference between the second form and the new form; and
based on the inheritance relationship and the identifies at least one difference, generating a web page that contains data entry elements for each field in the second form.

19. The computer readable medium of claim 18, wherein a change to at least one of a field and rule in the new form is automatically inherited by a corresponding at least one of a field and rule in the second form.

20. A server, comprising:
a memory configured to store instructions that include:
a form-building application configured to enable the server to output multiple different forms with information obtained from one or more data fields of a web page, wherein the form-building application is capable of dynamically outputting a first value from the one or more data fields to a first location in a first form and the first value to a second location in a second form depending upon whether a user selects the first form or the second form as a desired output; and
a processor operable to execute the instructions stored in the memory.

21. The server of claim 20, wherein the memory further includes instructions configured to automatically obtain information from at least one publically-available server that is subsequently output to the one or more data fields and wherein the one or more data fields correspond to data fields of a web page.
